(19) United States
(12) Patent Application Publication
(10) Pub. No.: US 2025/0289690 A1
(43) Pub. Date: Sep. 18, 2025

(54) CRANE WITH ELECTRIC POWER TAKE-OFF

(71) Applicant: Oshkosh Corporation, Oshkosh, WI (US)

(72) Inventors: Kevin Michael Bell, Mason City, IA (US); Glen Ashdown, Oshkosh, WI (US)

(73) Assignee: Oshkosh Corporation, Oshkosh, WI (US)

(21) Appl. No.: 19/078,232

(22) Filed: Mar. 12, 2025

Related U.S. Application Data
(60) Provisional application No. 63/564,829, filed on Mar. 13, 2024.

(51) Int. Cl. B66C 23/42; B60K 17/28; B60K 25/00; B60R 16/033; B62D 65/02; B66C 23/00

(52) U.S. Cl. CPC B66C 23/42; B60K 17/28; B60K 25/00; B60R 16/033; B62D 65/02; B66C 23/54; B66C 2700/0335

(57) ABSTRACT

A vehicle system includes a chassis, a prime mover, a body assembly, a boom assembly, an electrical accessory equipment system, and an electric power take-off system. The chassis supports a plurality of wheels. The prime mover is configured to provide energy to drive at least one of the plurality of wheels. The body assembly is supported by the chassis. The boom assembly is coupled to the body assembly and includes a hydraulic actuator. The electrical accessory equipment system is coupled to the body assembly. The electrical accessory equipment system includes one or more batteries, and an electric power take-off system electrically coupled to the electrical accessory equipment system. The electric power take-off system is configured to power the hydraulic actuator using electrical energy from the one or more batteries.

### CROSS-REFERENCE TO RELATED APPLICATIONS

This Application claims the benefit of and priority to U.S. Provisional Application No. 63/564,829, filed Mar. 13, 2024, the entire contents of which are hereby incorporated by reference herein.

### BACKGROUND

The present disclosure relates generally to the field of cranes and other lifting machines designed to raise, lower, load, unload, or otherwise move a load such as cargo, materials, and other items.

### SUMMARY

One exemplary embodiment relates to a vehicle including: a chassis, a prime mover, a body assembly, a boom assembly, an electric power take-off system, and an electrical accessory equipment system. The chassis supports a plurality of wheels. The prime mover is configured to provide energy to drive at least one of the plurality of wheels. The body assembly is supported by the chassis. The boom assembly is coupled to the body assembly and includes a hydraulic actuator. The electric power take-off system includes: an electric motor, and a hydraulic pump coupled to the electric motor. The hydraulic pump is configured to supply pressurized hydraulic fluid to the hydraulic actuator. The electrical accessory equipment system is coupled to the body assembly, and includes: one or more batteries, and a controller configured to selectively control allocation of power from the one or more batteries to the electric motor.

Another exemplary embodiment relates to a vehicle system including a chassis, a prime mover, a body assembly, a boom assembly, an electrical accessory equipment system, and an electric power take-off system. The chassis supports a plurality of wheels. The prime mover is configured to provide energy to drive at least one of the plurality of wheels. The body assembly is supported by the chassis. The boom assembly is coupled to the body assembly and includes a hydraulic actuator. The electrical accessory equipment system is coupled to the body assembly. The electrical accessory equipment system includes one or more batteries, and an electric power take-off system electrically coupled to the electrical accessory equipment system. The electric power take-off system is configured to power the hydraulic actuator using electrical energy from the one or more batteries.

Another exemplary embodiment relates to a method of manufacturing a vehicle. The method includes: coupling a boom assembly including a hydraulic actuator to the vehicle; coupling an electric power take-off system to the vehicle and the boom assembly, including coupling a hydraulic pump to the hydraulic actuator; and coupling an electrical accessory equipment system including one or more batteries to the vehicle and the electric power take-off system. In some embodiments, coupling the electrical accessory equipment system includes electrically coupling the one or more batteries to an electric motor that is configured to power the hydraulic pump.

Yet another exemplary embodiment relates to a crane vehicle. The crane vehicle includes a chassis supporting a plurality of wheels, a prime mover configured to provide energy to drive at least one of the plurality of wheels, and a vehicle body supported by the chassis. The crane vehicle also includes one or more batteries and an electric motor configured to provide energy to a hydraulics system. The hydraulics system is configured to operate one or more systems of the crane vehicle. An electric power take-off module is coupled to the vehicle body, the electric power take-off module comprising an electric power take-off system. The electric power take-off system is configured to selectively power at least one of the prime mover or the electric motor.

The invention is capable of other embodiments and of being carried out in various ways. Alternative exemplary embodiments relate to other features and combinations of features as may be recited herein.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a perspective view of a crane vehicle according to an exemplary embodiment;

FIG. 2 is a detail view of an Electrified Power Equipment system of the crane vehicle of FIG. 1 according to an exemplary embodiment; and

FIG. 3 is a perspective view of a boom assembly of the crane vehicle of FIG. 1, according to an exemplary embodiment.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

Referring to the FIGURES generally, disclosed herein are vocational vehicles including an at least partially hydraulically actuated crane system (which may also be referred to as a boom assembly) that is configured to be powered by an energy storage device (e.g., a battery pack) onboard the vocational vehicle. The vocational vehicle include an electrified power equipment system (EPEQ) onboard the vehicle that is configured to control allocation of power to an electric motor driving a hydraulic pump to power the hydraulic actuators of the crane system. The energy storage device, which is commonly a battery pack or battery assembly, can form part of the EPEQ system or be a separate module from the EPEQ system. In some embodiments, the EPEQ system is also configured toto provide power from the battery back to different subsystems of the vehicle. on the electric crane system, such as to an electric motor for a winch of the crane system.

According to an exemplary embodiment, the EPEQ system is configured as a standalone power system for the crane system (e.g., a boom assembly) that can operate separately from a prime mover that is used to power transit operations of the vehicle (e.g., separate from a prime mover that is configured to power the wheels of the vehicle). More specifically, embodiments disclosed herein relate to an EPEQ system and/or an energy storage device that is also configured to selectively provide hydraulic power to different subsystems of the electric crane system through an electric power take-off (E-PTO) system. The E-PTO system may be configured to selectively couple the energy storage device to an electric motor of the E-PTO that is coupled to a hydraulic pump of the E-PTO to power different hydraulic actuators of the crane. In some embodiments, the EPEQ system is configured to use the E-PTO to selectively power operation of the crane system based on an operating condition of the vehicle. For example, the EPEQ system and/or the E-PTO system may be configured to determine, based on an indication that the vehicle has been powered off in combination with a crane command signal, that the vehicle is at a worksite, and to couple the energy storage device with electric motor driving the hydraulic pump to perform lift operations. Such an arrangement can eliminate the need to operate other energy systems onboard the vehicle (e.g., an engine system, etc.), which can reduce fuel consumption and noise. Additionally, using battery power to operate the crane at a jobsite can also remove the requirement to operate an engine system at different rotational speeds at the job site, which can further extend the overall operating range of the vehicle.

As indicated above, in some embodiments, the E-PTO system receives electrical power from the energy storage device and provides the electrical power to an electric motor. The electric motor drives a hydraulic pump that provides pressurized hydraulic fluid to different vehicle subsystems, including those relating to boom movement of the crane, an air compressor, and/or other working components onboard the vehicle.

### Crane Assembly

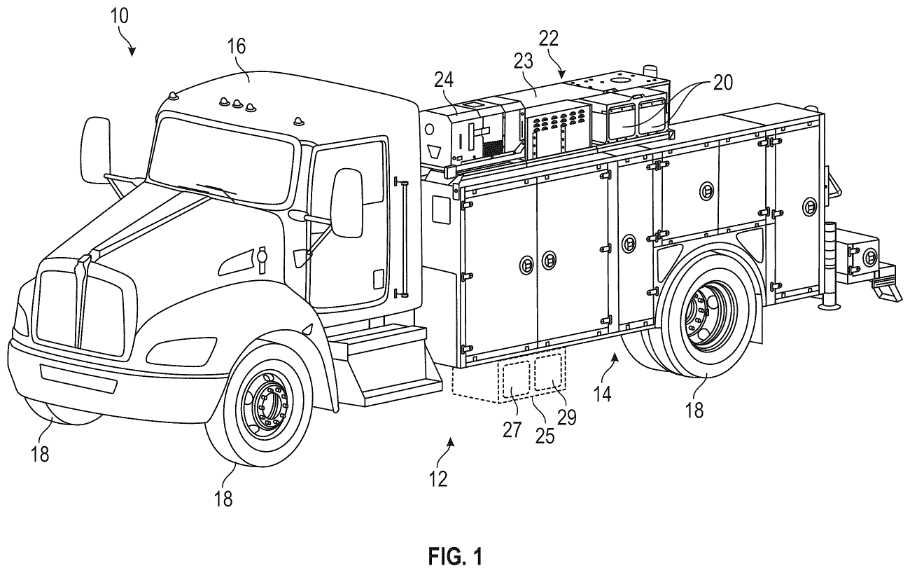

Referring to FIG. 1, a vehicle, shown as vehicle 10 (e.g., a vocational vehicle, a mobile crane, a boom truck, a mechanics truck, etc.), includes a chassis (e.g., a frame, etc.) and a body assembly, shown as body assembly 12, coupled to the chassis. The body assembly 12 defines a main body 14 and a cab 16. The cab 16 is coupled to a front end of the chassis, and includes various components to facilitate operation of the vehicle 10 by an operator (e.g., a seat, a steering wheel, hydraulic controls, etc.) as well as components that can execute commands automatically to control different subsystems within the vehicle 10 (e.g., computers, controllers, processing units, etc.).

The vehicle 10 further includes a prime mover coupled to the chassis at a position beneath the cab 16. The prime mover provides power to a plurality of motive members, for example, shown as wheels 18, and to other systems of the vehicle 10 (e.g., a pneumatic system, a hydraulic system, etc.). In one embodiment, the prime mover includes an internal combustion engine system (e.g., a diesel engine, etc.) that is coupled to the chassis and that is configured to power movement of the drivetrain. The internal combustion engine system may also provide power, such as via an alternator, to control operation of one or more vehicle subsystems under certain operating conditions.

In other embodiments, the prime mover includes a hybrid power system including an internal combustion engine system and a battery pack to power vehicle components. In yet other embodiments, the prime mover includes a fully electric energy system including one or more electric motors coupled to the chassis. The electric motor(s) may consume electrical power from an on-board energy storage device (e.g., one or more batteries 20, ultra-capacitors, hydraulic storage devices, etc.), from an on-board generator (e.g., an internal combustion engine and alternator), and/or from an external power source (e.g., overhead power lines, power rails, etc.) and provide power to the systems of the vehicle 10. In some examples, the on-board energy storage device is a plurality of rechargeable lithium-ion battery cells.

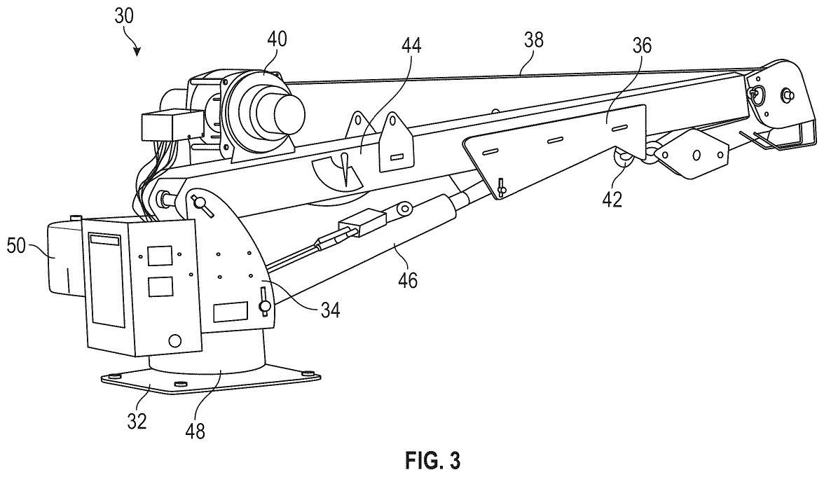

According to an exemplary embodiment, the vehicle 10 is configured to lift and move a load for a variety of purposes. The load is typically heavy and/or large and may be, for example, cargo, materials, components, machines, goods, etc. The vehicle 10 typically includes the main body 14 (e.g., platform, etc.) and a boom assembly 30 (shown in FIG. 3) extending from the main body 14. The main body 14 may be fixed or mobile. The boom assembly 30 is coupled to the main body 14 via a boom assembly mount 32 comprising a mounting flange and coupling members (e.g., bolts, screws, etc.). The boom assembly 30 also comprises a boom base 34 coupled to the boom assembly mount 32 and a boom arm 36 extending from the boom base 34. The boom assembly 30 supports a cable 38, which may be formed from metal wire, chains, rope, or other materials. A hoist 40 (e.g., a winch, an electric hoist, etc.) is used to wind and unwind the cable. The boom assembly 30 further includes a hook 42 or other tool hanging from the end of the boom assembly 30 opposite to the boom assembly mount 32 by the cable 38. The hook 42 is generally used to attach the cargo, materials, or other items to the cable 38 of the boom assembly 30. In some embodiments, the boom assembly 30 may include the hook 42 or other tool fastened to a rigid post or section, without the cable 38.

As further shown in FIG. 3, the boom assembly 30 also includes a hydraulic extension cylinder 44 inside the boom assembly 30 and a hydraulic lift cylinder 46 extending between the boom base 34 and the boom arm 36. The hydraulic extension cylinder 44 provides power to the boom assembly 30 for extension functions of the boom assembly 30, such as to extend the length of the boom arm 36. The hydraulic lift cylinder 46 provides power to the boom assembly 30 for lifting functions of the boom assembly 30, such as to adjust an angular orientation of the boom arm 36 relative to the main body or a ground surface. The boom assembly 30 further includes a hydraulic gear rotator 48 and a hydraulic power unit 50. The hydraulic gear rotator 48 provides power to allow the boom base 34 and the boom arm 36 to rotate about an axis (e.g., the axis at the coupling point of the boom assembly mount 32 and the main body 14). The hydraulic power unit 50 is shown in FIG. 3 as a power reservoir.

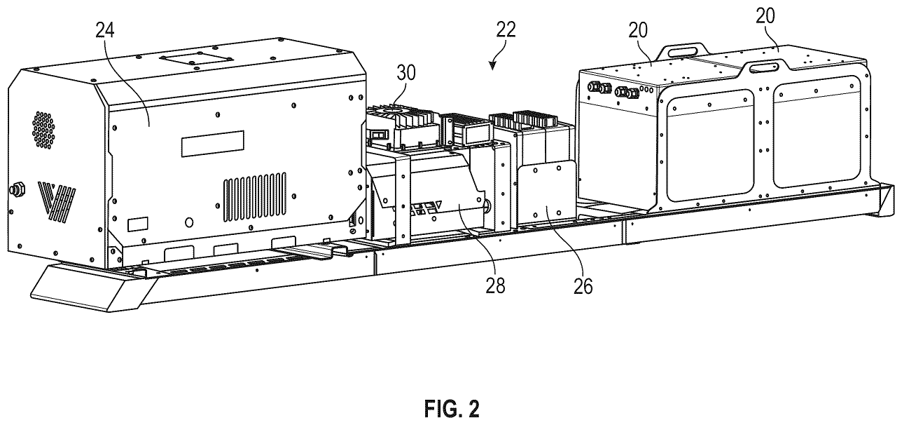

Referring again to FIGS. 1 and 2, the main body 14 of the vehicle 10 includes an Electrified Power Equipment (EPEQ) system 22 (e.g., an electrical power equipment system, an electrical accessory equipment system, an electrical crane equipment system, etc.) provided within an EPEQ housing 23 onboard the vehicle. The EPEQ system 22 may be coupled to a vehicle chassis and/or the body assembly 12 (e.g., the main body 14). In the embodiment of FIG. 1, the EPEQ system 22 is coupled to a cargo body portion of the body assembly 12 (e.g., the main body 14) that includes a cargo carrier (e.g., a cargo cabinet, a toolbox, etc.). The EPEQ system 22 is engaged with and extends along an upper wall of the cargo carrier. Such an arrangement can improve access to components of the EPEQ system 22 and can enable removal and replacement of the EPEQ system 22 and components thereof without having to disassemble other vehicle subsystems or body components.

In FIG. 2, a detail view of a portion of the vehicle 10 is shown, depicting the EPEQ system 22 without the EPEQ housing 23. The EPEQ system 22 includes an electric power control box 26 (discussed further herein), a motor controller 28 (e.g., a controller, etc.), and a shore power charger 29. The shore power charger 29 may recharge the batteries 20 or may serve to power the vehicle 10 directly. In some embodiments, the EPEQ system 22 also includes an inverter charger for the EPEQ system 22 that is located on other parts of the vehicle, such as under the body assembly 12, etc. In some embodiments, the vehicle 10 also includes a charger at another location along the vehicle, such as a 12 V to 48 V charger beneath the body assembly 12 (e.g., under the vehicle 10) or at another location along the vehicle).

The shore power charger 29 may be selectively electrically coupled to an external energy source (e.g., a power grid, a generator, a charging station, etc.) to deliver electrical energy to the vehicle 10 to charge the batteries 20 and/or directly power one or more components of the vehicle 10. The main body 14 of the vehicle 10 also supports the batteries 20 (e.g., one or more 48V batteries, etc.) and an air compressor 24. In some embodiments, the batteries 20 form part of the EPEQ system 22. The air compressor 24 may be hydraulically, diesel, or gas operated, or in some embodiments, an electrically-operated air compressor may also be used. In the embodiment shown, the air compressor 24 is an electrically powered air compressor that receives power from the batteries 20 via the EPEQ system 22.

The vehicle 10 includes one or more energy storage devices, shown as the batteries 20. The batteries 20 can be rechargeable lithium-ion batteries, for example. In some embodiments, the batteries 20 are configured to supply electrical power to the prime mover, which includes one or more electric motors. In such embodiments, the electric motors are coupled to the wheels 18 through a vehicle transmission, such that rotation of the electric motor (e.g., rotation of a drive shaft of the motor) rotates a transmission shaft, which in turn rotates the wheels 18 of the vehicle. The EPEQ is configured to provide electrical power from the batteries 20 to vehicle subsystems including working components of the vehicle such as the boom assembly 30 (e.g., the winch, etc.), additional electric motors, the air compressor 24, and/or other auxiliary systems, for example.

According to certain embodiments, the vehicle 10 may include various other types of energy storage devices, such as hydraulic storage devices and/or capacitors. For example, the vehicle 10 may include one or more hydraulic storage devices that are configured to store a pressurized fluid. The vehicle, the EPEQ system 22, and/or the E-PTO system, as will be further described, may also include at least one energy recovery device. For example, the vehicle, the EPEQ system 22, and/or the E-PTO system may include a turbine or other electric energy generator that is fluidly coupled to at least a portion of the hydraulic system such that, when the hydraulic storage device releases some or all of the pressurized fluid, the fluid flow may be converted to another type of energy (e.g., electrical energy) that can be stored in the batteries 20. According to various embodiments, the hydraulic storage devices may be in fluid communication with a hydraulics system discussed further below. Further, the energy storage devices may include one or more capacitors that enable energy clipping. For example, if a motor or hydraulic storage device outputs more energy than is needed by the vehicle 10, the capacitor may store that energy for use at a later time. In other embodiments, the EPEQ system 22 is configured to return power provided from the E-PTO system (e.g., via an electric motor of the E-PTO system) to the batteries 20.

The vehicle 10 can include both electric and hydraulic power systems. The main body 14 supports a primary battery (e.g., the batteries 20, etc.) that is configured to supply electrical power to the various systems on the body assembly 12 and the boom assembly 30. In some embodiments, the batteries 20 are also configured to supply electrical power to a prime mover, such as an electric motor powering rotation of the wheels of the vehicle. In some embodiments, such as where the vehicle includes an electric or hybrid-electric prime mover, the vehicle and/or the EPEQ system 22 may include a power distribution unit (PDU) is in communication with the batteries 20 and is configured to selectively monitor and supply electrical power from the batteries 20 to each of the body assembly 12 and the prime mover. The PDU can be a controller, processor, central processing unit (CPU), or other type of programmable or non-programmable device that monitors the batteries 20 and the systems on the body assembly 12 and chassis that request electrical power from the batteries 20. The PDU is configured to control the supply of electrical power from the batteries 20 to accommodate the power requests of the various systems on the boom assembly 30, chassis, and body assembly 12. For example, the PDU monitors the batteries 20 and controls contactors within the batteries 20 to direct electrical power to the various systems within the vehicle 10. In some examples, the PDU prioritizes electrical power delivery through the vehicle 10. The PDU can ensure that critical functions (e.g., the prime mover, etc.) receive electrical power before the auxiliary systems, like the E-PTO system, climate control systems, or radio, for example.

The PDU can control the supply electrical power from the batteries 20 to various subsystems onboard the vehicle (referred to herein generally as “body assembly 12”). In some examples, a disconnect (discussed further below) is positioned between the PDU and the body assembly 12 to selectively disable electrical power transmission from the batteries 20 to the body assembly 12. The disconnect provides selective electrical communication between the batteries 20 and the body assembly 12 that can allow the secondary vehicle systems (e.g., the boom assembly 30, etc.) to be decoupled and de-energized from the electrical power source. The disconnect can create an open circuit between the batteries 20 and the body assembly 12, such that no electricity is supplied from the batteries 20 to the various systems on the vehicle 10. The vehicle 10 can then be operated in a lower power consumption mode, given the reduced electrical load required from the batteries 20 to operate the vehicle 10. The disconnect further enables the vehicle 10 to conserve energy when the vehicle subsystems are not needed, and can also be used to lock out the various vehicle subsystems to perform maintenance activities. The disconnect further allows an all-electric vehicle chassis to be retrofit with hydraulic power systems, which can be advantageous for a variety of reasons, as hydraulic power systems may be more responsive and durable than fully electric systems.

The vehicle (e.g., the EPEQ system 22, etc.) further includes an E-PTO module 25 that at contains some or all of the E-PTO system that is discussed further below. The E-PTO system is configured to selectively drive the boom assembly 30 while the vehicle 10 is at a work site (e.g., a job site, a construction site, etc.). According to various embodiments, the E-PTO module 25 is removably coupled to the vehicle 10 such that the E-PTO module 25 may be removed from the vehicle 10. For example, the E-PTO module 25 may be a modular component of the EPEQ system 22 and/or the vehicle 10 that can be readily exchanged with another E-PTO module. In this sense, the E-PTO module 25 may be removed from the vehicle (e.g., to perform maintenance, etc.) and a different E-PTO module may be loaded into the vehicle to reduce downtime of the vehicle 10.

The E-PTO module 25 may be co-located with other components of the EPEQ system 22 on the body assembly 12. In other embodiments, the E-PTO module 25 may be located proximate the front of the vehicle 10, however, according to various embodiments, the E-PTO module 25 may be located elsewhere. For example, the E-PTO module 25 may be located proximate the rear of the vehicle 10. In other embodiments, the E-PTO module 25 or components thereof may be located under the vehicle 10. In other embodiments, the E-PTO system may be positioned within a housing above or within the main body 14, beneath a canopy extending over a portion of the cab 16, or within a dedicated housing alongside the body assembly 12. Although the E-PTO system may be in electrical communication with the batteries 20, the E-PTO system can be separate from and spaced apart from the EPEQ system 22 in some embodiments.

According to various embodiments, the E-PTO module 25 includes a layer of sound insulating material (e.g., a layer of acoustic foam (e.g., studio foam), sound insulation (e.g., batts made of mineral wool, rock wool, fiberglass, etc.), acoustic panels, acoustic fabrics, acoustic coatings (e.g., Mass Loaded Vinyl), rubber material, composite material, metal, etc.). For example, some or all of the E-PTO module 25 includes a layer of sound insulating material. The sound insulating material is configured to reduce a perceived audible output from the E-PTO system. For example, according to various embodiments, the E-PTO module 25 contains a hydraulic pump 27 and an electric motor 29 of the E-PTO system. The hydraulic pump 27 and the electric motor 29 may produce high levels of noise pollution when in use. The sound insulation material may reduce the amount of noise pollution emitted from the E-PTO system by absorbing some of the sound. Further, according to various embodiments, the sound insulating material may be flame resistant, thereby reducing the risk of fire within the E-PTO module 25.

The vehicle 10 (e.g., the boom assembly 30) may further include one or more activation switches that are accessible from the exterior of the vehicle 10. For example, the vehicle 10 may include an activation switch proximate the front of the vehicle 10, and/or an activation switch proximate the rear of the vehicle 10, and/or at another location along the body assembly 12 and/or chassis. Each activation switch may enable an operator of the vehicle 10 to input an external input, thereby causing the E-PTO system to enter idle mode, as discussed further below, or input a function request, thereby causing the E-PTO system to enter work mode, as discussed further below. For example, the operator may trigger the activation switch thereby causing the electric motor and/or the hydraulic pump to be activated. In this sense, the activation switches enables the operator of the vehicle 10 to increase pressure within the hydraulic system (e.g., for the boom assembly 30) from outside of the vehicle 10.

The vehicle 10 may also include one or more operator detectors positioned about the vehicle 10 and/or along other portions of the vehicle. The operator detectors are configured to detect the presence of an operator outside of the vehicle 10, for example, if an operator exits the cabin 16 of the vehicle 10 and approaches either the front of the rear of the vehicle 10. The operator detectors may include video cameras, motion sensors, proximity sensors, thermal sensors, and/or any other sensor configured to detect the presence of a person. Each operator detector may enable an operator of the vehicle 10 to automatically input an external input by approaching the front and/or the rear of the vehicle 10, thereby causing the E-PTO system to enter idle mode, as discussed further below, or input a function request by approaching the front and/or the rear of the crane, thereby causing the E-PTO system to enter work mode, as discussed further below. For example, the operator may trigger the operator detector, thereby causing the electric motor and/or the hydraulic pump to be activated. In this sense, the operator detectors enable the operator of the vehicle 10 to automatically increase pressure within the hydraulic system from outside of the vehicle 10 by approaching the front or rear of the vehicle.

### Disconnect and Circuitry

With continued reference to FIGS. 1 and 2, the vehicle 10 includes a disconnect. The disconnect can be used to selectively power operation of certain components of the vehicle 10 (e.g., the air compressor 24, etc.). The disconnect can also be used to selectively power operation of the boom assembly 30 (e.g., when the vehicle 10 is at a work site, etc.). In some embodiments, the disconnect is part of the E-PTO system and is arranged within the E-PTO module 25. In other embodiments, the disconnect can be positioned on other components of the vehicle 10 (e.g., positioned between the batteries 20 and the E-PTO system, in the EPEQ system 22, etc.). The disconnect provides selective electrical communication between the batteries 20 and the E-PTO system that can allow the secondary vehicle systems (e.g., the boom assembly 30, etc.) to be decoupled and de-energized from the electrical power source. The disconnect can create an open circuit between the batteries 20 and the E-PTO system, such that no electricity is supplied from the batteries 20 to the electric motor. Without electrical power from the batteries 20, the electric motor will not drive the hydraulic pump(s). Pressure within the hydraulic system will gradually decrease, such that none of the vehicle subsystems relying upon hydraulic power will be functional. The boom assembly 30 can then be operated in a lower power consumption mode, given the reduced electrical load required from the batteries 20 to operate the boom assembly 30. The disconnect further enables the vehicle 10 to conserve energy when the vehicle subsystems are not needed, and can also be used to lock out the various vehicle subsystems to perform maintenance activities. The disconnect further allows an all-electric vehicle chassis to be retrofit with hydraulic power systems, which can be advantageous for a variety of reasons, as hydraulic power systems may be more responsive and durable than fully electric systems. In some examples, the E-PTO system includes a dedicated secondary battery that is configured to supply electrical power to the E-PTO system if the disconnect is tripped, such that the secondary vehicle systems (e.g., the boom assembly 30, etc.) can remain operational even when the E-PTO system is not receiving electrical power from the batteries 20.

FIGS. 1 and 2 depict the electric power control box 26 of the EPEQ 22 that can function as the disconnect and/or as an electrical connector panel including high and/or low voltage connections between the EPEQ 22 system and various components, including the E-PTO module 25 (e.g., the electric motor, etc.). The electric power control box 26 generally includes a housing and a cover or door that together define a waterproof or semi-waterproof cavity. The cavity receives and supports electrical connections between the E-PTO system and the batteries 20 to create a selective electrical coupling between the two. Fittings are positioned about the perimeter of the housing and define passages through the housing to receive electrical inputs. The fittings can be rigidly coupled (e.g., welded) or removably coupled (e.g., threaded) to the housing so that a water-tight seal is formed between the fittings and the housing. In some examples, a low voltage connector tube extends through the housing and into the cavity as well. The housing is configured to be mounted to the body assembly 12 of the vehicle 10. The housing may include a mounting flange extending around at least a portion of the housing and including a plurality of mounting holes that can be used to fasten the housing to the body assembly 12 of the vehicle 10. In some examples, a vent is formed within an underside of the housing to allow cooling air to enter into the cavity.

One or more circuits (e.g., power conditioners, power conditioning units, power converters, etc.) are designed to form a reliable and efficient selective electrical coupling between the batteries 20 and the E-PTO system. The circuits are further designed to be integrated into vehicles 10 having different battery types or systems so that the E-PTO system can be incorporated into the vehicle. The circuits further allow a user to lock out and disable the E-PTO system without affecting the rest of the vehicle 10 functions, so that the vehicle 10 can still be driven or otherwise operated independent of the E-PTO system function. This operational mode can be useful when power conservation is necessary, such as when the batteries 20 have limited remaining power.

A controller (e.g., a motor controller) can initiate electrical power transfer between the batteries 20 and the E-PTO system, and can control operation of the electric motor for the E-PTO system. In some examples, the controller monitors the position of the disconnect. For example, the controller can receive information from one or more disconnect feedback lines to determine whether the disconnect is in the open or closed position. If the controller determines that the disconnect is open, the controller can issue a command to open a contactor switch within a negative high voltage contactor. An auxiliary low voltage source can then toggle the contactor switch open. In some examples, the controller also communicates with the batteries 20 and the associated circuit(s) to open contactors associated with the batteries 20 to further isolate the batteries 20 from the E-PTO system. Similarly, the controller can control the electric power control box 26 so that the contactor switch within the negative high voltage contactor closes whenever the controller determines that the disconnect is closed.

The controller communicates with the batteries 20 (e.g., to a power distribution unit (PDU) of the chassis in communication with the batteries 20) to initiate the transmission of electrical power from the batteries 20 to and through the electric power control box 26. In some examples, the controller communicates a detected voltage at an inverter providing power to electrical functions of the E-PTO system (e.g., the electric motor), which can indicate whether or not the disconnect is open or closed. If the contactor switch within the negative high voltage contactor is open, the controller can communicate with the batteries 20 to ensure that the contactor switches associated with the batteries 20 are open as well. Accordingly, no high voltage will be provided from the batteries 20 to the electric power control box 26. If the controller requests the contactors within the PDU of the batteries 20 to open, but confirmation that the contactors are open is not received by the controller, the controller will prevent the negative high voltage contactor and associated switch from closing. Closing the negative high voltage contactor before pre-charging the negative high voltage high voltage contactor could couple the batteries 20 to the electric power control box 26 in a way that might otherwise cause an inrush current that could weld the contactors or even blow a main fuse within the inverter. Accordingly, this condition is preferably avoided by the controller, and the electric power control box 26, more generally.

Similarly, the controller communicates with the batteries 20 to indicate that the batteries 20 can be joined with the E-PTO system (e.g., the electric motor) through the inverter and the electric power control box 26. The controller monitors the status of the electric power control box 26. Upon detecting that the disconnect has been closed and receiving confirmation that the contactors within the batteries 20 (e.g., the PDU) are open, the controller closes the contactor within the negative high voltage contactor. The controller then initiates a pre-charging process to provide an initial voltage on each of a high voltage input and a high voltage output. In some examples, the controller controls the switch to close, thereby closing a pre-charge circuit and providing an initial voltage onto the high voltage input and the high voltage output. In some examples, the pre-charge circuit operates in conjunction with the auxiliary low voltage source, which can pass an initial charge at a lower voltage through to the inverter to charge the capacitive elements within the inverter. Once the controller detects that an appropriate pre-charge level has been reached within the inverter and along the high voltage input and the high voltage output, the controller opens the switch and closes the contactor switch within the negative high voltage contactor. The controller then sends instructions to the batteries 20 or PDU to open the battery contactor switches, thereby providing electrical power from the batteries 20 to the E-PTO system. In some examples, the batteries 20 and PDU include the pre-charge circuit, such that the pre-charging operation can be left to the batteries 20.

Using the systems and methods described herein, any crane vehicle can be effectively outfitted with an E-PTO system that can convert electrical power to hydraulic power to provide pressurized hydraulic fluid to various subsystems on the crane vehicle, including to the boom assembly 30. The E-PTO system includes a disconnect that allows the E-PTO system to be decoupled from the battery of the vehicle 10 and/or the EPEQ system 22 so that the vehicle can be operated in a low power mode that allows the vehicle to drive while the boom assembly 30 and/or other hydraulic systems are disabled. The disconnect can lock out the E-PTO system so that the E-PTO system is disconnected from any electrical power sources that might otherwise cause the inverter, the electrical motor, or the hydraulic pump to operate during a maintenance procedure. The disconnect can be a manual switch that can be readily accessed by a user to couple or decouple the E-PTO system from the batteries 20 of the vehicle 10.

### E-PTO System

The vehicle 10 (e.g., the body assembly 12, the EPEQ system 22) supports the E-PTO system, hydraulics, and the auxiliary systems that are in communication with a central controller, such as the controller of the EPEQ system 22. The controller communicates with the PDU to issue electrical power requests that can then be processed and/or otherwise handled by the PDU to transmit electrical power from the batteries 20 through to the systems to be powered. The controller is in communication with a memory (e.g., a cloud-based memory, an archive, a database, onboard memory, etc.) that can supply a variety of different control parameters and information to execute different vehicle functions. In some examples, the memory is in communication with a network (e.g., the internet, a fleet management system, etc.) that provides information to the memory for use by the vehicle 10. For example, route-based data or past performance data can be provided to the vehicle 10 through the network and/or the memory to the controller.

The controller can distribute electrical power received from the batteries 20 and PDU or via other power conditioners of the EPEQ system 22 to the various different systems on the vehicle 10, including the E-PTO system, the hydraulics, and the various auxiliary systems. The E-PTO system, for example, is configured to receive electrical power from the batteries 20 and convert the electrical power to hydraulic power. In some examples, the E-PTO system includes an electric motor driving the hydraulic pump. According to various embodiments, one or more sensors are configured to detect fluid pressure within the hydraulic system. According to various embodiments, the E-PTO system includes a transmission positioned inline between the electric motor and the hydraulic pump. The controller may control the transmission to optimize performance of the E-PTO system. The hydraulic pump pressurizes hydraulic fluid onboard the vehicle 10, which can then be supplied to various hydraulic cylinders (e.g., the hydraulic extension cylinder 44, the hydraulic lift cylinder 46, etc.) and actuators present upon the body assembly 12 of the vehicle 10. For example, the hydraulic pump can provide pressurized hydraulic fluid to the hydraulic extension cylinder 44 and the hydraulic lift cylinder 46 on the boom assembly 30 of the vehicle 10. The hydraulics can be in communication with the controller, which can communicate with the electric motor and the hydraulic pump to deliver the desired hydraulic loads. Simultaneously, the controller can communicate with the PDU to request the necessary battery power load to drive the electric motor to supply pressurized fluid to the hydraulics. In some examples, the controller provides electrical power from the batteries 20 to the inverter, which can convert DC power from the batteries 20 (and from the PDU) to AC power for use by the electric motor. In some examples, the inverter can be used to vary the frequency of the transformed AC power to adjust the performance of the electric motor. In some examples, the inverter can be used to convert electrical power from the batteries 20 into AC power for use by the electric motor as well. In some examples, each of the chassis and the body assembly 12 include separate inverters that can be used to supply AC electrical power to components on the chassis and body assembly 12, respectively. The frequency output of the inverter can be adjusted by the controller and/or a variable frequency drive.

The controller at least partially controls the pump and the electric motor to deliver pressurized hydraulic fluid to accommodate variable pump loads that may be requested by the hydraulics during normal operation of the boom assembly 30. The controller receives signals from various inputs throughout the vehicle 10 and can subsequently control different components within the body assembly 12 hydraulic circuit to execute different tasks. For example, the controller may receive an input from one or more buttons within the cab 16 of the vehicle 10 that prompt the lifting functions of the vehicle 10 to move in order to raise and/or lower a load held by the vehicle 10. Upon receiving an input requesting an adjustment of the pump load (e.g., requested movement of the boom system), the controller can activate or adjust an output of the electric motor and the pump to deliver pressurized hydraulic fluid from a hydraulic fluid reservoir to the one or more actuators forming the pump load to carry out the requested operation. The controller can work with the hydraulic pump to supply hydraulic fluid to one or more of the boom system and the various other subsystems upon the body assembly 12.

In some embodiments, the controller is also in communication with various auxiliary systems on the vehicle body assembly 12 and/or on the chassis. For example, the controller may communicate with and/or control the operation of an HVAC system, a global positioning system (GPS), the cab controls, vehicle suspension, and other subsystems present upon the vehicle 10. The controller can provide communication between the auxiliary systems and the PDU, and can selectively permit the transmission of electrical power from the batteries 23 to the auxiliary systems on the vehicle 10. In some examples, the body assembly 12 further supports a secondary battery. The secondary battery can be configured to power the controller and/or other subsystems on the body assembly 12, including the E-PTO system and the auxiliary systems. In some embodiments, the secondary battery is placed in selective communication with the prime mover to provide a backup ignition or drive source if the primary batteries 20 become disabled or run low on power.

As discussed above, some or all of the components of the E-PTO system may be contained within the E-PTO module 25. The vehicle 10 may include an interface that interfaces with the E-PTO module 25. For example, the interface may include one or more hydraulic fluid line connectors configured to couple the hydraulic pump to the hydraulics system. Additionally, the interface may include one or more electrical interfaces configured to provide power to and from the E-PTO module 25. According to various embodiments, the E-PTO module 25 may also include an energy storage device, such that the E-PTO system may operate solely off the energy storage device included in the E-PTO module 25.

According to various embodiments, the E-PTO module 25 may include more than one hydraulic pump and/or more than one electric motor. For example, the E-PTO module 25 may include two or more electric motors configured to drive the hydraulic pump. According to various embodiments, including additional electric motors and/or hydraulic pumps in the E-PTO module 25 will enable the E-PTO system to provide more power to the hydraulics system. Since the E-PTO module 25 can be easily exchanged with another E-PTO modules, different E-PTO modules may be selected based on the desired use of the vehicle 10. For example, if the vehicle 10 is intended to be used for particularly heavy lifting, an E-PTO module with more than one hydraulic pump and/or electric motor may be installed into the vehicle 10.

### Location-Based Operation

The vehicle 10 is also configured to execute a variety of different location-based and condition-based processes that can link data received or generated by the body assembly 12 to the prime mover and batteries 20 to help perform different functions of the vehicle 10. For example, the vehicle 10 can include a GPS that is positioned within the cab 16 or elsewhere upon the body assembly 12 to monitor a current location of the vehicle 10. The GPS communicates with the controller which can, based upon the detected location of the vehicle 10, modify vehicle performance by activating, deactivating, or optimizing different vehicle subsystems. The controller communicates with the memory and/or the network to access information in real time corresponding to desired performance characteristics associated with a location of the vehicle 10. Similarly, the vehicle 10 (and GPS) can include a series of condition sensors that are configured to detect one or more of weather conditions, traffic conditions, roadway conditions, and/or other collectable data along a route or in a certain location. The vehicle 10 can once again communicate the data from the GPS and associated sensors to the controller, which can then execute a series of commands that modify the amount or distribution of electrical power sent from the batteries 20 to the body assembly 12 to control the vehicle 10.

For example, the GPS can work with the controller (and the memory and/or the network) to recognize a variety of different geo-fences that are established for the vehicle 10. The GPS can communicate with the controller and PDU to control operation of the prime mover and the associated steering system to transition the vehicle 10 to an autonomous or semi-autonomous mode of operation corresponding to a particular geo-fence. The geo-fences can correspond to different locations that might require or desire different vehicle performance measures. For example, if the vehicle 10 transitions onto a highway, the associated geo-fence might limit or discontinue power transmission to the E-PTO so that a larger amount of electrical power from the batteries 20 is available for use by the prime mover to drive the vehicle 10 at higher speeds. Another geo-fence can correspond to a work site. The controller can provide instructions to the E-PTO system, the hydraulics, and the auxiliary systems to execute an idle operation mode. During the idle operation mode, the prime mover can be shut off while the vehicle subsystems continue to operate. For example, the prime mover of the vehicle 10 may be shut off to preserve fuel or power, while the system of the boom assembly 30 is still operational and functioning.

In some examples, the controller also monitors the direction of travel of the vehicle 10 as it passes through a geo-fence. For example, if the controller detects or receives an indication that the vehicle 10 has passed a geo-fence traveling in reverse, the controller can transition the vehicle 10 to semi-autonomous or fully-autonomous mode to complete a load positioning process to position, raise, lower, and/or release the load. The controller can control each of the prime mover, the steering system, the E-PTO, and the hydraulics of the boom assembly 30 to automatically execute the load positioning process. If the controller detects or receives an indication that the vehicle 10 has passed a geo-fence traveling forward, the controller may wait until the controller detects the vehicle 10 traveling in reverse before transitioning the vehicle to semi-autonomous or fully-autonomous mode.

Other parameters of the vehicle 10 may be adjusted based upon geo-fencing as well. For example, detected vehicle location (e.g., by the GPS) can be cross-referenced or supplemented with information from the memory and/or the network to provide different performance parameters based upon the location of the vehicle 10. In some examples, the memory stores optimized or pre-programmed performance parameters related to the prime mover or the vehicle suspension (e.g., the chassis) that can be adjusted based on the detected location of the vehicle 10. In some examples, the controller can limit one or more of the prime mover or overall vehicle speed, the available torque to drive the prime mover, and/or the permissible acceleration rate of the vehicle 10 based upon the current location of the vehicle 10 detected by the GPS.

The GPS and data received by the GPS can also be communicated externally from the vehicle 10. For example, the controller can receive positioning data from the vehicle 10 that corresponds to a current location. The controller can communicate the current position (or the current position and a future planned route or location) for the vehicle 10 to a fleet management system, an operator, a work site, etc.

As indicated above, the GPS can also include other types of sensors to associate additional condition-based data with location-based data. For example, the GPS can include weather sensors that monitor the weather conditions outside the vehicle 10. If the weather sensors detect severe weather, the GPS can report severe weather to the controller, which can in turn limit or otherwise restrict the functionality of the prime mover. Temperatures above or below set temperature thresholds may also impact the performance of the vehicle 10. For example, if the GPS and associated sensors determine that the ambient temperature is below a threshold temperature (e.g., below 0 degrees C.), the controller can limit the functionality of certain auxiliary systems, as the expected electrical load of the HVAC is much higher. Similar processes can be carried out if the ambient temperature exceeds a threshold level (e.g., above 30 degrees C.). Accordingly, the vehicle 10 can adjust the vehicle performance and energy consumption based on detected weather conditions.

The GPS can also include road quality sensors. For example, vibrational sensors or imaging devices can be positioned along the body assembly 12 or on the chassis to monitor the vehicle 10 as it traverses a route. If one of the sensors detects a roadway defect (e.g., a pothole, etc.), for example, the GPS can attribute location-based data with the detected road defect. The positioning and severity of the road defect can be stored within the memory and sent to the network. In some examples, the roadway defect data can be used to influence performance characteristics of the vehicle 10 as it travels a route that is known to include roadway defects. For example, the controller can adjust the suspension of the chassis to provide additional dampening because rougher roadways are expected. The suspension can also be adjusted so that the body assembly 12 sits higher above the wheels 18 to further limit or prevent any unwanted contact between the body assembly 12 and the ground below. Operations of the boom assembly 30 may be limited or altered to prevent unwanted movement or damage to a load. In some examples, the data associated with roadway defects and location can be useful to third parties as well. Accordingly, this data can be stored on the network or within the memory and provided or licensed to cities or municipalities to alert transportation departments of deteriorating roadway conditions. The data could also inform managers of work sites as to conditions at or near the work site.

According to various embodiments, the vehicle 10 may control the E-PTO system based on the route or the location. For example, the controller may active the E-PTO system based on an anticipated lifting event that typically occurs during at a given location. In this sense, the controller may automatically cause the E-PTO system to enter an idle mode or a work mode in response to a change in the location identified by the GPS.

In some examples, the cab controls include operator detecting sensors that can selectively disable the operation of the vehicle 10, including the boom assembly 30. The operator detecting sensors are configured as proximity sensors that detect the presence of a key or tag within a specified target range. The key or tag can be worn or embedded within a vest that is to be worn by the operator of the vehicle 10. The operator detecting sensors can then sense the presence of the operator within the cab 16 of the vehicle, for example, which can then be communicated to the controller that the boom assembly 30 can be operated. In other examples, the proximity sensors are positioned at or near the boom assembly 30, and the boom assembly 30 is disabled if the sensor detects the key or tag within a predetermined distance from the boom assembly 30. In some examples, the sensor is a camera or other type of live imaging devices that monitors an area and communicates with the controller to disable operation of the vehicle 10 or the boom assembly 30 if an operator is within a designated no occupancy zone. By monitoring the position of the driver or operators of the vehicle 10, systems can be automatically disabled until the operator is in a preferred position relative to the vehicle 10.

In some examples, the cab controls include multiple displays within the cab 16 of the vehicle 10. For example, a primary display can be centered along the dashboard (e.g., aligned with the steering wheel, etc.) and a secondary display can be positioned alongside the driver's seat or aligned with a center console. In some examples, the primary screen is incorporated directly into the steering wheel. The cab controls are configured to control the displays within the cab 16 depending upon the detected operation of the prime mover and based upon information received by one or more of the PDU and the controller. For example, during normal forward operation of the vehicle 10, the primary display may show various vehicle performance characteristics, including vehicle speed, remaining battery life, motor temperature, fluid pressure, and the like. The secondary display may show information about the subsystems on the vehicle, including the hydraulics, such as the boom assembly 30. In some examples, the secondary display provides a visual indication from a camera that is positioned in line with the boom assembly 30 that can be used by the operator to position the vehicle 10 relative to a load to be picked up or a location to move or place a load. If the cab controls receive an indication that a boom assembly 30 process is going to be performed, the data presented on the displays may switch. The driver or operator can remain focused with his or her head facing forward so that the front of the vehicle 10 can be watched at the same time that the camera is displaying the positioning of the boom assembly 30 relative to the load on the primary display. The secondary display can then present the various vehicle performance characteristics that are presented by the primary display under normal conditions. A similar process can be carried out when the vehicle 10 begins traveling in reverse. The primary display can present the live images provided by the back-up camera, which can allow the driver to better position the vehicle 10 and avoid otherwise awkward body positioning to drive the vehicle 10 rearward. Optionally, emergency information (e.g., battery life, oil pressure, etc.) can be always displayed on the primary display, regardless of vehicle operational mode.

According to various embodiments, the cab 16 may include a user interface (e.g., displayed on a touch screen display). The user interface is configured to receive operator inputs such that the operator can control one or more components of the vehicle 10, as is discussed further herein.

### Power Distribution and Management

The vehicle 10 can also include several power saving or power generation features to help further extend the life of the batteries 20 and extend the performance time of the vehicle 10. For example, the HVAC can be significantly simplified to reduce the number of pumps or compressors within the system. In some examples, the HVAC within the body assembly 12 (and the cab 16, specifically) is in communication with the controller, the PDU, and the batteries 20. The HVAC can be a single integrated thermal management system that is configured to supply heating, cooling, and air flow to the entire body assembly 12. Under normal or standard operating conditions, the HVAC can require a significant power draw from the batteries 20. The power draw necessary to achieve desired climate control conditions is amplified when ambient outdoor temperatures are very high or very low. To avoid excessive power draw from the batteries 20, the PDU and the controller can be configured to reduce, limit, or disable the HVAC under certain operating conditions. For example, if the PDU communicates that the remaining battery life is low, the controller can reduce the operation of the HVAC to partial functionality. For example, pumps and compressors within the HVAC may be disconnected from power but the fans can continue operating. If the remaining battery life continues to fall, the PDU and controller can fully disable the HVAC so that the remaining battery life is conserved for use with the boom assembly 30.

The controller and PDU are further configured to adjust the power distribution from the batteries 20 to the body assembly 12 based upon detected conditions within the batteries 20 or upon the vehicle 10, generally. The PDU is configured to prioritize the systems within the vehicle 10 so that electrical power from the batteries 20 is distributed to critical systems before auxiliary systems. In some examples, the vehicle 10 is configured to operate in a “limp home” mode. When the remaining battery life falls below a set threshold (e.g., 10 percent charge remaining, 5 percent charge remaining, etc.), the PDU and the controller can communicate to block, disable, or limit the operation of the different systems upon the body assembly 12. The HVAC can be limited or temporarily disabled, the E-PTO can be disconnected from electrical power (e.g., the electric motor can be stopped), and the auxiliary systems can be disconnected from the batteries 20. In some examples, the vehicle 10 is configured with two tiers of reduced operation. For example, when the remaining charge on the batteries 20 falls below a first threshold (e.g., 10 percent), functionality of the E-PTO, the hydraulics, and the auxiliary systems are reduced. The GPS, for example, can continue to monitor the location of the vehicle 10 and can communicate with the controller and PDU to allow for limited operation of the boom assembly 30 upon determining that the vehicle 10 is positioned within or at a certain location. If the remaining battery power falls below a second threshold (e.g., 5 percent), the PDU can reduce power supply from the batteries 20 to the body assembly 12 so that only the prime mover and the cab controls (e.g., the dashboard and steering) remain operational until the vehicle 10 is reconnected to the power source. The PDU can limit the acceleration curve and/or maximum output of the prime mover to further conserve battery power.

In some examples, the vehicle 10 is configured to include supplemental power supplies and/or energy saving devices. For example, one or more solar panels can be positioned along the body assembly 12. In some embodiments, solar panels extend along a top of the cab 16 and/or the main body 14. The solar panels can capture solar energy, which can be converted into usable battery power that can be stored and/or used by the batteries 20. Additionally or alternatively, the vehicle 10 can be outfitted with regenerative brakes. The brakes can harvest rotational energy or heat generated by the brakes while the vehicle 10 drives so that battery power can is conserved. The brakes can resupply the energy captured to the PDU or to the batteries 20.

The controller can determine if the E-PTO system should be engaged. For example, the controller may determine that the E-PTO system will not be used in the near future. For example, the controller may utilize route-based data or past performance data to determine that the E-PTO system is not needed until the vehicle 10 arrives to a certain location. If the controller determines that the E-PTO system does not need to be engaged, the controller will cause the E-PTO system to remain in standby mode. Alternatively, if the controller determines that the E-PTO system should be engaged, the controller may cause the E-PTO system to enter idle mode. For example, if the controller determines that the E-PTO system may be needed in the near future, the controller may cause the E-PTO system to enter idle mode. For example, the controller may utilize location-based data or past performance data to determine that the E-PTO system is or will be needed relatively soon. Further, the controller may receive an external input (e.g., an operator input on the user interface, triggering of the operator detector, actuation of the activation switch, etc.) and cause the E-PTO system to enter idle mode in response to the external input.

The controller also may determine if a function is requested. For example, an operator may input a function request to use the lifting function of the boom assembly 30. Alternatively or additionally, the activation switch may be activated by an operator, which may qualify as a function request. Further, the operator detectors may detect an operator proximate the front or the rear of the vehicle 10, which may qualify as a function request. If a function request is received by the controller, then the controller may cause the E-PTO system to enter work mode. In work mode, the hydraulic pump and/or the electric motor may be active. For example, the electric motor may be operating at a speed that is higher than when the E-PTO system is in standby mode and higher than when the E-PTO system is in idle mode. Further, the hydraulic pump may provide higher hydraulic pressure to the hydraulics system than when the E-PTO system is in standby mode and higher than when the E-PTO system is in idle mode. For example, in work mode, the E-PTO system may provide high enough fluid pressure to satisfy the function request.

### E-PTO Arrangements

In further examples, the vehicle 10 can include multiple E-PTOs such that the vehicle 10 includes several distinct hydraulic circuits that are independently operable to control various functions and/or the subsystems. The additional E-PTOs can help provide a more controllable and easier-to-maintain vehicle 10. The batteries 20 are further configured to provide power to one or more E-PTOs. The E-PTOs as discussed above, each include an electric motor that is configured to drive one or more hydraulic pumps to provide pressurized hydraulic fluid to different systems on the vehicle 10.

The electric motors present within each of the E-PTOs are configured to draw electricity from the batteries 20. Each of the E-PTOs can include an inverter to convert DC electrical power received from the batteries 20 into AC electric power for use by the electric motor. The electric motor can be an AC induction or permanent magnet-style AC motor that can be controlled using a variable frequency drive (VFD). In some examples, the VFD is included within the inverter. The VFD can then be used to control a speed of the electric motor, which in turn controls an output of the hydraulic pump that is coupled with the electric motor. In some embodiments, the inverter includes a 48 V to 12 V converter that is configured to reduce the voltage output from the batteries 20 to one or more vehicle subsystems (e.g., the vehicle 10, the air compressor 24, etc.).

Each of the E-PTOs can be configured to convert electrical power received from the batteries 20 into hydraulic power that can be used to operate the various hydraulic cylinders (e.g., the hydraulic extension cylinder 44, the hydraulic lift cylinder 46, etc.) and other hydraulics present aboard the vehicle 10. Because each of these E-PTOs operates using electrical power received from the batteries 20, a single disconnect can be used to selectively electrically connect each of the E-PTOs to the batteries 20 and to a power source on the vehicle chassis. As explained above, the disconnect can be operated manually to decouple each of the E-PTOs from the batteries 20. The inclusion of the disconnect, as discussed above, can be helpful in maintenance situations where lockout and/or tag out procedures are being used. Similarly, the inclusion of the disconnect can be helpful in reducing the power consumption of the body assembly 12 when the batteries 20 are operating in a low or reduced power state.

In another arrangement of the vehicle 10, the vehicle 10 includes a separate and dedicated disconnect for each of the E-PTOs. The disconnects can be associated with the E-PTOs such that individual hydraulic systems aboard the vehicle 10 can be selectively decoupled from the batteries 20 for maintenance or lower power operation. For example, if the batteries 20 are in a lower power setting, an operator could use the disconnect to electrically decouple the corresponding E-PTO from the batteries 20, so as to cease operation. The inclusion of multiple disconnects can also facilitate maintenance procedures, as less equipment needs to be taken offline to service specific components.

Although the description of the E-PTO system and the disconnect have been described within the context of the vehicle 10, the same or similar systems can also be included on other vehicles without significant modification. Accordingly, the disclosure should be considered to encompass the E-PTO system and the disconnect in isolation and incorporated into any type or variation of crane or vehicle.

The electric motor is further configured to draw electricity (e.g., electrical power) from the batteries 20 and convert the electricity to mechanical power. The E-PTO system includes an inverter to convert DC electrical power received from the batteries 20 into AC electric power for use by the electric motor. The electric motor can be an AC induction or permanent magnet-style AC motor that can be controlled using a variable frequency drive (VFD). In some examples, the VFD is included within the inverter. The VFD can then be used to control a speed of the electric motor, which in turn controls an output speed of one or more of the hydraulic pump that are coupled with the electric motor.

The electric motor may be coupled to a transmission arrangement that is configured to transfer an output from the electric motor to one or more of the hydraulic pumps. The transmission arrangement may enable the electric motor to individually power each of the hydraulic pumps. For example, each hydraulic pump may provide hydraulic power (e.g., pressure, energy, etc.) to a different system of the vehicle 10. In this sense, the electric motor may provide power to just one hydraulic pump (e.g., via the transmission arrangement) without powering the other two hydraulic pumps. For example, an operator of the vehicle 10 may engage the boom assembly 30 without engaging a subsystem. In this example embodiment, the transmission arrangement may engage the electric motor with the respective hydraulic pump while disengaging the electric motor with the hydraulic pumps that are not directly coupled to the boom assembly 30.

According to various embodiments, the transmission arrangement may be configured to transfer an output from the electric motor to two or more hydraulic pumps simultaneously. For example, the transmission arrangement may transfer mechanical power to three hydraulic pumps. According to various embodiments, the amount of power transferred to the three hydraulic pumps is the same. According to other embodiments, the amount of power transferred to the three hydraulic pumps may be different. For example, the transmission arrangement may transfer a first proportion of the output from the electric motor to a first hydraulic pump, a second proportion of the output to a second hydraulic pump, and a third proportion of the output to a third hydraulic pump. According to various embodiments, the first proportion, the second proportion, and the third proportion may be fixed proportions. For example, 60% of the output may be transferred to the first hydraulic pump, 30% of the output may be transferred to the second hydraulic pump, and the remaining 10% of the output may be transferred to the third hydraulic pump. Alternatively, the transmission arrangement may be able to alter the first proportion, the second proportion, and the third proportion based on demand requirement. Further, according to various embodiments, the transmission arrangement may provide a minimum threshold output to each hydraulic pump. For example, the boom assembly 30 and/or the subsystems may include hydraulics that are configured to idle at a minimum pressure. In this example, the transmission arrangement may be configured to transfer a sufficient output to each of the hydraulic pumps to maintain the desired idle pressure. The transmission arrangement may further be configured to increase the first proportion output while maintaining a minimum threshold output for the second proportion and the third proportion.

A method of manufacturing a vehicle according to the description provided herein may include a number of processes. The method may include coupling a boom assembly including a hydraulic actuator to the vehicle. The method may include coupling an electric power take-off system to the vehicle and the boom assembly, including coupling a hydraulic pump to the hydraulic actuator. Additionally, the method may include coupling an electrical accessory equipment system including one or more batteries to the vehicle and the electric power take-off system. In some embodiments, coupling the electrical accessory equipment system includes electrically coupling the one or more batteries to an electric motor that is configured to power the hydraulic pump.

In some embodiments, the method may include additional processes, such as communicatively coupling a controller of the electrical accessory equipment system to the electric motor and a prime mover of the vehicle. Additionally, the method may include selectively electrically coupling, by the controller, the electric motor to the one or more batteries responsive to an indication that the prime mover has been deactivated.

Although this description may discuss a specific order of method steps, the order of the steps may differ from what is outlined. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection steps, processing steps, comparison steps, and decision steps.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like, as used herein, mean the joining of two members directly or indirectly to one another. Such joining may be stationary (e.g., permanent, etc.) or moveable (e.g., removable, releasable, etc.). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” “between,” etc.) are merely used to describe the orientation of various elements in the figures. It should be noted that the orientation of various elements may differ according to other exemplary embodiments, and that such variations are intended to be encompassed by the present disclosure.

It is important to note that the construction and arrangement of the crane as shown in the exemplary embodiments is illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the components described herein may be constructed from any of a wide variety of materials that provide sufficient strength or durability, in any of a wide variety of colors, textures, and combinations. Accordingly, all such modifications are intended to be included within the scope of the present inventions. Other substitutions, modifications, changes, and omissions may be made in the design, operating conditions, and arrangement of the preferred and other exemplary embodiments without departing from scope of the present disclosure or from the spirit of the appended claims.

What is claimed is:

1. A vehicle comprising:
a chassis supporting a plurality of wheels;
a prime mover configured to provide energy to drive at least one of the plurality of wheels;
a body assembly supported by the chassis;
a boom assembly coupled to the body assembly, the boom assembly comprising a hydraulic actuator;
an electric power take-off system comprising:
an electric motor; and
a hydraulic pump coupled to the electric motor, the hydraulic pump configured to supply pressurized hydraulic fluid to the hydraulic actuator; and
an electrical accessory equipment system coupled to the body assembly, the electrical accessory equipment system comprising:
one or more batteries; and
a controller configured to selectively control allocation of power from the one or more batteries to the electric motor.

2. The vehicle of claim 1, wherein the electrical accessory equipment system further comprises an inverter configured to provide electrical energy to the electrical motor from the one or more batteries.

3. The vehicle of claim 1, wherein the boom assembly includes a boom arm, and wherein the hydraulic actuator is configured to control movement of at least a portion of the boom arm relative to the body assembly.

4. The vehicle of claim 1, wherein the electric motor is a first motor and the electric power take-off system further includes a second motor configured to receive electrical energy from the one or more batteries and provide power to the hydraulics system in response to receiving the electrical energy from the one or more batteries.

5. The vehicle of claim 1, wherein the controller is configured to control allocation of power from the one or more batteries to the electric motor based on an operating condition of the prime mover.

6. The vehicle of claim 1, wherein the electric power take-off module is disposed at a first position along the body assembly, and the electrical accessory equipment system is disposed at a second position along the body assembly that is remote from the first position.

7. The vehicle of claim 1, wherein at least one of the electric power take-off system or the controller is configured to selectively power the electric motor based on a location of the crane vehicle.

8. The vehicle of claim 1, wherein at least one of the electric power take-off system or the electrical accessory equipment system further comprises a disconnect electrically coupled between the electric power take-off system and the one or more batteries.

9. A vehicle comprising:
a chassis supporting a plurality of wheels;
a prime mover configured to provide energy to drive at least one of the plurality of wheels;
a body assembly supported by the chassis;
a boom assembly coupled to the body assembly, the boom assembly including a hydraulic actuator;
an electrical accessory equipment system coupled to the body assembly, the electrical accessory equipment system comprising one or more batteries; and
an electric power take-off system electrically coupled to the electrical accessory equipment system, the electric power take-off system configured to power the hydraulic actuator using electrical energy from the one or more batteries.

10. The vehicle of claim 9, wherein the electrical accessory equipment system further includes an inverter configured to reduce a voltage provided by the electric power-take off system from the one or more batteries.

11. The vehicle of claim 9, wherein the boom assembly includes a boom arm, and wherein the hydraulic actuator is configured to control movement of at least a portion of the boom arm relative to the body assembly.

12. The vehicle of claim 9, wherein the electrical accessory equipment system is configured to control allocation of power from the one or more batteries to the electric power take-off system based on an operating condition of the prime mover.

13. The vehicle of claim 9, wherein the electric power take-off system comprises an electric motor configured to receive electrical energy from one or more batteries to power a hydraulic pump.

14. The vehicle of claim 9, wherein the electric power take-off module is disposed at a first position along the body assembly, and the electrical accessory equipment system is disposed at a second position along the body assembly that is remote from the first position.

15. The vehicle of claim 9, wherein the electric power take-off system or the electrical accessory equipment system further includes a switch configured to be actuated by an operator of the vehicle, the switch configured to activate the electric power take-off system in response to being actuated by the operator.

16. The vehicle of claim 9, wherein at least one of the electric power take-off system or the electrical accessory equipment system is configured to selectively supply pressurized hydraulic fluid to the hydraulic actuator based on a location of the vehicle system.

17. The vehicle of claim 9, further comprising a disconnect electrically coupled between the electric power take-off system and the one or more batteries.

18. A method of manufacturing a vehicle, the method comprising:
coupling a boom assembly comprising a hydraulic actuator to the vehicle;
coupling an electric power take-off system to the vehicle and the boom assembly, comprising coupling a hydraulic pump to the hydraulic actuator; and
coupling an electrical accessory equipment system comprising one or more batteries to the vehicle and the electric power take-off system, comprising electrically coupling the one or more batteries to an electric motor that is configured to power the hydraulic pump.

19. The method of claim 18, further comprising communicatively coupling a controller of the electrical accessory equipment system to the electric motor and a prime mover of the vehicle.

20. The method of claim 19, further comprising selectively electrically coupling, by the controller, the electric motor to the one or more batteries responsive to an indication that the prime mover has been deactivated.
